(19) United States
(12) Patent Application Publication
(10) Pub. No.: US 2014/0262189 A1
(43) Pub. Date: Sep. 18, 2014

(54) CURABLE COMPOSITIONS AND FLUID CONNECTIONS MADE THEREWITH

(71) Applicant: HENKEL US IP LLC, Rocky Hill, CT (US)

(72) Inventors: Shabbir Attarwala, Simsbury, CT (US); Ifeanyi Chris Broderick, East Hampton, CT (US); Prakash S. Patel, Algonquin, IL (US)

(21) Appl. No.: 14/227,539

(22) Filed: Mar. 27, 2014

Related U.S. Application Data
(63) Continuation of application No. 12/882,593, filed on Sep. 15, 2010, now abandoned.
Application No. 12/882,593 is a continuation-in-part of application No. 12/358,798, filed on Jan. 23, 2009.
(60) Provisional application No. 61/245,432, filed on Sep. 24, 2009.
(60) Provisional application No. 61/023,568, filed on Jan. 25, 2008.
(60) Provisional application No. 61/028,395, filed on Feb. 13, 2008.

(51) Int. Cl. F28F 1/12; F16L 43/00; F16L 13/10

(52) U.S. Cl. CPC F28F 1/12; F16L 13/103; F16L 43/00
USPC 165/182; 285/285.1; 285/134.1; 156/294

(57) ABSTRACT

A curable composition comprising an isocyanate material; method of using this curable composition and fluid connection incorporating cured reaction products of this composition are provided.

### CROSS REFERENCE TO RELATED APPLICATIONS

This application is a continuation of U.S. application Ser. No. 12/882,593, filed Sep. 15, 2010, which claims the benefit of U.S. Provisional Application No. 61/245,432, filed Sep. 24, 2009; and a continuation-in-part of U.S. application Ser. No. 12/358,798, filed Jan. 23, 2009, which claims the benefit of U.S. Provisional Application No. 61/023,568, filed Jan. 25, 2008 and the benefit of U.S. Provisional Application No. 61/028,395, filed Feb. 13, 2008; the contents of each of which are incorporated by reference.

### FIELD

A curable composition comprising isocyanate materials and method of using this curable composition and fluid connection incorporating cured reaction products of this composition are provided. In one embodiment the isocyanate materials comprise modified methylene diphenyl diisocyanate polymers and prepolymers.

### BRIEF DESCRIPTION OF RELATED TECHNOLOGY

Refrigeration systems that rely on a refrigerant phase change to provide a temperature differential are used in numerous applications including commercial and residential refrigeration, freezing, air conditioning and heating systems. Refrigeration systems typically include a compressor, a condenser, a metering device and an evaporator all fluidly connected and containing a refrigerant. The compressor takes low pressure refrigerant vapor and pressurizes the vapor. Refrigeration compressors can be of the reciprocating piston, screw, rotary, scroll or centrifugal type. The condenser takes high pressure refrigerant vapor from the compressor, removes heat from this vapor and condenses the vapor to a pressurized liquid. The metering device modulates or restricts flow of the liquid refrigerant to the evaporator. Metering devices range from a capillary tube as used in residential refrigerators to a modulating environmental conditions such as exposure to weather and cleaning chemicals. The connections must be useful with refrigeration system components and tubing of different sizes and materials. The connections must be useful with refrigeration system components having large gaps between the assembled components. The connections are desirably fabricated quickly. Some assembly operations form high pressure connections in less than ten seconds. After assembly it is desirable that the connections can be put into use quickly. Some assembly operations pressurize and start the refrigeration system less than one hour after the connections are formed. The connections are desirably made by workers with minimal training using inexpensive equipment. It is desirable that the connections can be fabricated without using hazardous materials or hazardous processes. Naturally it is desirable that the connection can be fabricated at a low cost. The connections should also be repairable without special equipment.

Typically, smaller refrigeration systems use two processes to form high pressure connections: high temperature fusion joining processes such as welding or brazing and low temperature mechanical joining processes that rely on swaging or plastic deformation of the joined components. However, despite a long period of use neither of these processes is completely satisfactory for a high pressure connection. High temperature processes require expensive automated equipment or skilled workers. High temperature processes require use of hazardous or flammable fluxes. Only selected brazing filler materials are useful in refrigeration system connections. Brazing a high pressure connection having an aluminum member is, at best, difficult and requires specialized equipment and brazing materials. The high temperatures and open flames used in fusion joining processes are dangerous when flammable refrigerants are present. Low temperature swaging processes such as the LOKRING process permanently deform the attached parts. This prevents disassembly of the joined parts and makes subsequent repair of a damaged connection difficult. Swaging processes also add expensive components to the connection and require use of expensive equipment. The swaging components must be selected based on connection diameter, thereby requiring a user to maintain a plurality of connectors for each connection member size or limit the connection sizes used. Workers must be trained to correctly use the swaging equipment and swaging process. Even with training, swaging of parts having large gaps or swaging of small diameter parts is difficult at best. It is not usually possible to form a swaged connection during a field repair.

U.S. Pat. No. 3,687,019 discloses a two part tube joint construction for a hermetic compressor. This tube joint construction relies on an interference fit between parts, uses a mechanical crimp between the parts and an anaerobic sealant. Even with an interference fit between parts, a mechanical crimp and anaerobic sealant the tube joint construction appears to be limited to an internal pressure of only up to 500 pounds per square inch.

U.S. Pat. No. 3,785,025 also discloses a two part tube joint construction for a hermetic compressor. This tube joint construction relies on an interference fit between parts, uses a mechanical crimp between the parts and an anaerobic sealant and suffers from the same internal pressure deficiencies as those in the '019 patent.

U.S. Pat. No. 6,494,501 discloses a multiple part joint construction including a double wall pipe connector. This pipe connector requires two spaced walls defining a gap between which a tube and sealant is disposed. Such a connector is difficult to form, limited to use with only one tube diameter and adds an additional part and operation to the formation of a tubing connection.

Anaerobically curable compositions have been proposed to form high pressure connections. Composition in the high pressure connection bond area will cure to form a strong, refrigerant proof bond; however composition outside of this bond area will cure slowly or not at all. This uncured composition outside of the bond area may be more susceptible to movement by refrigerant or refrigerant oil during use. Thus, care must be taken to avoid placement of the curable composition outside the bond area or to ensure removal or curing of composition outside of the bond area.

Despite the state of the technology, there remains a need for a composition curable outside of the high pressure connection bond area.

### SUMMARY

As used herein a high pressure connection is a connection that can retain gas or liquid at a maximum pressure of at least 1,200 pounds per square inch, advantageously at a maximum pressure of at least 1,500 pounds per square inch and more advantageously at a maximum pressure of at least 2,000 pounds per square inch. The high pressure connection is advantageously useful in compressed gas systems and refrigeration systems.

In one embodiment the high pressure connection consists essentially of a first distal joint portion, a second distal joint portion and cured reaction products of the disclosed curable composition therebetween. As used herein a “high pressure connection consisting essentially of a first distal joint portion, a second distal joint portion and cured reaction products of the curable composition” indicates that high pressure connections incorporating other structural elements are not included. Thus, high pressure connections that require other structural elements to form the connection, for example, weld material, threads or threaded interconnection, a ferrule, a driver ring, a lock ring, a swage ring, plastic deformation of the distal joint portions or cured reaction products of epoxy resins alone are disclaimed in this aspect.

In this embodiment the high pressure connection is formed by providing the first distal joint portion. The first distal joint portion is generally tubular and includes a substantially uniform cylindrical outer surface free from threads, a substantially uniform cylindrical inner surface free from threads having an inner diameter defining a bore through the member, and a circumferential end connecting the outer and inner surfaces.

The second distal joint portion is provided. The second distal joint portion is generally tubular and includes a substantially uniform cylindrical outer surface free from threads and defining an outer diameter smaller than the first distal joint portion inner diameter, a substantially uniform cylindrical inner surface free from threads defining a bore through the member, and a circumferential end connecting the outer and inner surfaces.

The second distal joint portion is slidingly received into the first distal joint portion with the second distal joint portion outer surface adjacent the first distal joint portion inner surface. The cylindrical area between these distal joint surfaces defines a bond area.

The curable composition is provided in the bond area. The curable composition can be applied to at least one of the distal joint portions before assembly or to the bond area after assembly.

The curable composition is exposed to conditions appropriate to initiate curing and cure the composition and maintain the second distal joint portion within the first distal joint portion thereby forming the high pressure connection. Plastic deformation of the material comprising the first distal joint portion or the second distal joint portion is not required to form the high pressure connection. Plastic deformation refers to a permanent change in the shape of an object caused by an applied force.

The curable composition includes either or both of a curable, aromatic isocyanate material and a curable, aliphatic isocyanate material. The curable composition can additionally comprise one or more of a cure accelerator, a co-reactant, a polymer matrix and a composition modifier.

In one embodiment the isocyanate material comprises a methylene diphenyl diisocyanate (MDI) material and the curable composition comprises an isocyanate cure accelerator component. The MDI material can advantageously be a modified MDI material such as carbodiimide and uretoimine modified MDI materials or modified MDI prepolymers. A combination of MDI materials can also be used. Advantageously the MDI material has a NCO content of about 8% to about 31% and desirably about 18% to about 28% by weight. This curable composition cures by an isocyanate cure mechanism. Isocyanate cure mechanism typically involves reaction between an isocyanate group and an active hydrogen such as is present in water or an alcohol. Because the isocyanate cure mechanism is effective in aerobic conditions the curable composition will cure outside of the bond area as well as inside the bond area.

In one embodiment the isocyanate material comprises a methylene diphenyl diisocyanate (MDI) material and the curable composition comprises a cure accelerator component, a (meth)acrylate ester co-reactant component and an anaerobic cure accelerator component. This curable composition cures by both an anaerobic cure mechanism and an isocyanate cure mechanism. The composition can have both anaerobic and isocyanate cure mechanisms within the bond area and only an isocyanate cure mechanism outside of the bond area.

The disclosed curable compositions have especially beneficial properties, such as being surface insensitive, e.g. being able to cure over both active and inactive surface materials. The disclosed composition can be used with distal joint portions independently selected from copper, aluminum, steel, coated steel and plastic. The composition is advantageous when one distal joint portion is aluminum and the other distal joint portion is independently selected from copper, aluminum, steel, coated steel and plastic. The disclosed curable compositions can cure through a separation between the second distal joint portion outer surface and the first distal joint portion inner surface (cure through gap or CTG) of from about 0 mm (an interference fit) to about 0.4 mm or more. Cured reaction products of the disclosed curable compositions have good resistance to refrigerant gases and refrigerant oils. The curable compositions are especially effective in curing both “inside” and “outside” the bond area of the mating distal joint portions. The term “inside” the bond area refers to the area between the overlying mated distal joint portions. The term “outside” the bond area refers to areas of the mated distal joint portions that are not overlying. Anaerobic adhesives may not cure in the aerobic conditions outside of the high pressure connection bond area. The disclosed compositions with an isocyanate cure mechanism will cure both inside and outside the high pressure connection bond area. Thus, there is substantially no uncured composition in the high pressure connections to be moved by refrigerant. The high pressure connection resulting from use of the disclosed curable composition can be used to retain gasses or liquid refrigerant at a maximum pressure greater than 1,200 pounds per square inch, advantageously at a pressure greater than 1,500 pounds per square inch and more advantageously at a pressure greater than 2,000 pounds per square inch within the system.

In some embodiments the high pressure connection is a two part connection. As used herein a two part tube connection includes only the two tubes or members to be joined. Each tube includes one distal joint portion so that the distal joint portion of one tube is disposed within the distal joint portion of the other tube. A two part tube connection does not use fittings or connectors to join the two tubes.

In some embodiments the high pressure connection may be a multiple part connection. As used herein a multiple part tube connection includes the two tubes or members to be joined and further includes an additional short fitting or short connector. Each tube includes one distal joint portion and the connector includes two distal joint portions. The distal joint portion of each tube is slidingly received within or over the respective distal joint portions of the connector. Typically in multiple part connections the tubes are in end to end relationship and are not disposed within each other.

In some embodiments the high pressure connection is advantageously used in a refrigerator, a freezer, a refrigerator-freezer, an air conditioner, a heat pump, a residential heating, ventilation and air conditioning (“HVAC”) system, a commercial HVAC system or a transportation HVAC system such as in an automobile, truck, train, airplane, boat, etc. In some embodiments the high pressure connection is advantageously used in a gas compression system such as an air compressor system.

In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in earlier materials and processes or that are otherwise not necessary to the achievement of the function and/or objective of the present disclosure.

When the word “about” is used herein it is meant that the amount or condition it modifies can vary some beyond the stated amount so long as the function and/or objective of the disclosure are realized. The skilled artisan understands that there is seldom time to fully explore the extent of any area and expects that the disclosed result might extend, at least somewhat, beyond one or more of the disclosed limits. Later, having the benefit of this disclosure application and understanding the embodiments disclosed herein, a person of ordinary skill can, without inventive effort, explore beyond the disclosed limits and, when embodiments are found to be without any unexpected characteristics, those embodiments are within the meaning of the term “about” as used herein.

### BRIEF DESCRIPTION OF THE DRAWINGS

Referring now to the drawings wherein like elements are numbered alike in the several Figures:

FIG. 1 is a schematic representation of a refrigeration system.

FIG. 2 is an exploded, schematic elevational view of portions of two tubular members forming a two part connection.

FIG. 3 is an exploded, schematic, elevational view of portions of two tubular members forming a multiple part connection.

FIG. 4 is a schematic, elevational view of one embodiment of high pressure connections comprising portions of two tubular members bonded to a “U” shaped connector.

FIG. 5 is a perspective view of a two part, high pressure connection comprising an aluminum member and a copper member.

FIG. 6 is a perspective view of a portion of a refrigerator. The arrows illustrate two part, high pressure connections formable according to the method of this disclosure

FIG. 7 is a perspective, partially broken away view or part of a heat exchanger,

### DETAILED DESCRIPTION

A curable composition comprising an isocyanate material; methods of using this curable composition and articles of manufacture incorporating cured reaction products of this composition are provided. In one embodiment the article of manufacture is a fluid connection. The fluid connection can advantageously be a high pressure connection. The high pressure connection is useful for a number of applications. However, refrigeration system connections have unique and stringent requirements not all of which are necessarily or present in other types of fluid connections. The disclosed high pressure connection is advantageously useful in preparing a connection in a refrigeration system impermeable to refrigerants and refrigerant oils. For clarity refrigeration systems are described herein, however as noted refrigeration systems are not the only systems that may benefit from the advantages of the subject application. In another embodiment the article of manufacture is a fin or frame bonded to the exterior of a tube by cured reaction products of this composition.

With reference to FIG. 1, refrigeration systems include a compressor 10, a condenser 12, a metering device 14 and an evaporator 16 all fluidly connected by tubing and containing a refrigerant. There are a plurality of high pressure connections (not shown for clarity) between, and within, the tubing, compressor, condenser, metering device, evaporator and any accessories. The connections are preferably two part connections as exemplified in FIG. 2 although multiple part connections as exemplified in FIG. 3 are known in refrigeration systems. Each two part connection typically comprises two hollow, tubular members 22, 24 with a cured reaction product of curable composition therebetween.

Each tubular hollow member is independently comprised of a material, for example copper, aluminum, steel, coated steel and plastic. Coated steel includes a steel member coated with another material, for example a steel member coated with copper. In one embodiment one tubular connector is comprised of aluminum and the other tubular connector is comprised of copper. In one embodiment both tubular connectors are comprised of aluminum. In one embodiment at least one of the tubular members is plastic.

Each tubular member typically has a length many times, for example five to ten times or more, its diameter. One tubular member 22 has a distal joint portion 26 including a substantially uniform cylindrical outer surface 28 free from threads, a substantially uniform cylindrical inner mating surface 30 free from threads having an inner diameter and a circumferential end 32 connecting the outer 28 and inner 30 surfaces. The inner diameter may have an optional chamfer or expansion of the distal joint portion 26 adjacent the end 32. The other tubular member 24 has a distal joint portion 36 including a substantially uniform cylindrical outer mating surface 38 free from threads and defining an outer diameter, a substantially uniform cylindrical inner surface 40 free from threads and a circumferential end 42 connecting the outer 38 and inner 40 surfaces. The outer diameter may not have any optional chamfer or expansion of the distal joint portion 36 adjacent the end 42. The inner diameter of distal joint portion 26 is larger than the outer diameter of distal joint portion 36 to allow distal joint portion 36 to be disposed within distal joint portion 26. Since the members 22, 24 are generally formed without machining, e.g. from purchased tubing or swaged tubing, each member can have a considerable range of distal joint portion diameters. Given this range of diameters the gap between a complementary set of members 22, 24 can be in the range of about 0.02 mm to about 0.20 mm or more. No interference or press fit between the inner diameter of distal joint portion 26 and the outer diameter of distal joint portion 36 is required to form a high pressure connection.

To prepare a high pressure connection complementary members 22, 24 are provided. The mating surfaces 30, 38 should be clean and free of contamination. Abrasion of one or both mating surfaces may be advantageous.

A primer composition is not required. Connections made using no primer and only the curable composition are suitable for use as a fluid connection, including use as a high pressure connection.

A curable composition is applied to a mating surface 30, 38. The smaller diameter distal joint portion 36 is slidingly disposed within the larger diameter distal joint portion 26. Some rotation of the distal joint portions may be beneficial to distribute the curable composition around the entirety of the mating surfaces but is not required. A bond area is defined between mating surfaces 30, 38 between ends 32, 42. The assembly is exposed to conditions appropriate to cure the composition. Cured reaction products of the curable composition in the bond area will bond the members 22, 24 and form the high pressure connection. The high pressure connection will maintain pressure greater than about 1200 pounds per square inch and advantageously greater than about 1500 pounds per square inch and more advantageously greater than about 2000 pounds per square inch after fully curing.

The exterior surface 28 of distal joint portion 26 defines an exterior surface of the high pressure connection and the interior surface 40 of distal joint portion 36 defines an interior surface of the high pressure connection. Plastic deformation in the material of either distal joint portion 26, 36 after disposition of the smaller diameter distal joint portion 36 within the larger diameter distal joint portion 26 is not needed to form a high pressure connection and is advantageously avoided.

As shown best in FIG. 3, one embodiment of a multiple part connection typically comprises two hollow, tubular members 46, 50 and a hollow connector 48. One tubular member 46 has a distal joint portion 52 including a substantially uniform cylindrical outer surface 54 free from threads, a substantially uniform cylindrical inner surface 56 free from threads having an inner diameter and a circumferential end 58 connecting the outer 54 and inner 56 surfaces. The other tubular member 50 has a distal joint portion 62 including a substantially uniform cylindrical outer surface 64 free from threads and defining an outer diameter, a substantially uniform cylindrical inner surface 66 free from threads and a circumferential end 68 connecting the outer 64 and inner 66 surfaces. The connector 48 has two distal joint portions 72, 74. Distal joint portion 72 includes an outer surface 76 free from threads, an inner surface 78 free from threads and a circumferential end 80. Distal joint portion 74 includes an outer surface 84 free from threads, an inner surface 86 free from threads and a circumferential end 88. The connector 48 is short, for example with a typical length less than five to ten times its diameter.

The inner diameter of distal joint portions 72 and 74 is larger than the outer diameter of distal joint portions 52 and 62 to allow distal joint portions 52 and 62 to be disposed within member 48. Since the members 46, 48, 50 are generally formed without machining, e.g. from purchased tubing or swaged tubing, each member can have a considerable range of distal joint portion diameters. Given this range of diameters the gap between a complementary set of members 46, 48 and 48, 50 can be in the range of about 0.02 mm to about 0.20 mm. In other embodiments the connector 48 is sized to fit within distal joint portions 52, 62.

To prepare a high pressure connection complementary members 46, 48 are provided. The mating surfaces 54, 78 should be clean and free of contamination. Abrasion of one or both mating surfaces may be advantageous. A curable composition is applied to one mating surface 54, 78. The smaller diameter distal joint portion is slidingly disposed within the larger diameter distal joint portion. Some rotation of the distal joint portions may be beneficial to distribute the curable composition around the entirety of the mating surfaces but is not required. A bond area is defined between mating surfaces 54, 78 and between ends 58, 80. The curable composition will at least partially cure both inside the bond area and outside the bond area to bond members 46, 48 and form the high pressure connection. Distal joint portions 62 and 74 are processed in the same manner to form a second high pressure connection between the ends 88, 68 of distal joint portions 74, 62. The high pressure connection will maintain pressure greater than about 1200 pounds per square inch and advantageously greater than about 1500 pounds per square inch and more advantageously greater than about 2000 pounds per square inch after fully curing. Plastic deformation in the material of any distal joint portion after disposition of the smaller diameter distal joint portions within the larger diameter distal joint portions is not needed to form a high pressure connection and is advantageously avoided. The connector may be straight as shown in FIG. 3 or otherwise shaped such as a “U” shaped return bend, exemplified in FIG. 4, useful to fluidly connect condenser tubes.

The connector distal portions may have a smaller diameter than the corresponding tubular member distal portions so that the connector distal portions are disposed within the tubular member distal portions. Similarly, while the methods are described with reference to the cylindrical connectors most often used, connectors of other shapes, for example square or rectangular tubing, are possible.

In some applications it may be desirable to apply the curable composition to the distal joint portions after their assembly. For example, refrigeration capillary tubes have distal joint portions defining a very small diameter. Applying a non-flowable curable composition to the distal joint portion prior to assembly may increase the possibility that the composition is introduced into the connection interior during assembly. To lessen this possibility the curable composition can be applied to the bond area after the second distal joint portion is slidingly received into the first distal joint portion. Thus the curable composition can be applied to the assembled distal joint portions. These variations are advantageously useful with lower viscosity compositions that can wick or flow into the bond area between the adjacent distal joint portions in the assembly.

In some applications it may be desirable to apply the portions of the curable composition to different distal joint portions before assembly. For example, one part of the curable composition can be preapplied to one distal joint portion at the time of tube manufacture and stored. The other part of the curable composition can be preapplied to a different distal joint portion at the time of tube manufacture and stored. Thus, an article of manufacture comprising the curable composition preapplied to a distal joint portion can be formed at one location and sold or transported to another location. At a desired time complementary articles are taken from storage and one distal joint portion is disposed into the other distal joint portion and the assembly is exposed to conditions suitable to cure the preapplied parts of the composition to form the connection.

In some applications it may be desirable to apply different portions of the curable composition at the same time. For example, each part of a two part composition can be placed in a dispenser and dispensed to the bond area, either before or after the distal joint portions are assembled. The portions can be dispensed onto the bond area separately or the portions can be mixed such as by using a mix nozzle. The assembly is exposed to conditions suitable to cure the composition to form the connection.

In some applications the curable composition can be useful to prepare a high pressure connection comprising multiple, male distal joint portions in a single female distal joint portion using the above methods.

In some less preferred variations plastic deformation in the material of either distal joint portion after disposition of the smaller diameter distal joint portion within the larger diameter distal joint portion may be used in addition to the curable composition.

In another embodiment the curable composition can be useful to prepare a pipe connection comprising threadedly engaged male and female distal joint portions and cured reaction products of the composition therebetween.

In another embodiment the curable composition can be used to bond heat exchanger components such as fins, supports, sideplates and/or a frame to the external surface of a tube. With reference to FIG. 7, heat exchangers 100 such as used in air conditioning and other HVAC equipment typically comprise parallel arrays of tubes 102 through which heated or cooled materials flow. Air flowing through the heat exchanger is heated or cooled by contact with the tubes exterior surface 104. A plurality of spaced fins 106 are mounted to the exterior surface 104 of the tubes to increase heat exchange surface area and the amount of heat or cold that can be transferred to air. The fins 106 are thin plates perpendicularly arranged with respect to the tubes 102. The fins may be corrugated or bent to further increase surface area. In some variations the fins can spiral around the tube exterior. The fins 106 have a plurality of apertures 108 through which the tubes 102 extend. The fins 106 are held onto the tubes 102 by a friction fit between the fin aperture 108 and tube exterior surface 104.

The sideplate 110 is part of a frame 112 that supports heat exchanger components such as tubes 102 and fins 106 for protection and mounting in a HVAC system. The tubes typically enter and exit the heat exchanger through apertures 114 in a side plate 110. The sideplate 110 may not contact the tube exterior surface 104 at all. During use the fins 102 and/or side plate 110 may vibrate against the tube exterior surface 104 causing objectionable noise. The disclosed curable composition can be applied to the tube exterior surface 104 and/or fin 106 and/or junction of the fin aperture 108 and tube exterior surface 104. The disclosed curable composition can be applied to the tube exterior surface 104 and/or side plate 110 and/or junction of the sideplate aperture 114 and tube exterior surface 104. Cured reaction products of the composition bond the fin 106 to the tube 102 to prevent vibration. Similarly, cured reaction products of the composition bond the side plate 110 to the tube 102 to prevent vibration. The disclosed curable composition can bridge and cure through the sometimes large (0.4 mm or more) gap between the tube exterior surface and the side plate aperture. Cured reaction products of the composition can withstand vibration, thermal cycling, thermal shock and environmental conditions present in heat exchangers.

The curable composition comprises a curable isocyanate material. The curable composition can additionally comprise one or more of a cure accelerator, a co-reactant, a polymer matrix and a composition modifier.

The curable isocyanate material comprises an aromatic isocyanate material, an aliphatic isocyanate material or a combination of an aromatic isocyanate material and an aliphatic isocyanate material. Some aromatic isocyanate materials include, for example, tolylene diisocyanate (TDI) and methylene diphenyl diisocyanate (MDI). Some aliphatic isocyanate materials include, for example, hexamethylene diisocyanate (HDI) and isophorone diisocyanate (IPDI). Adducts and partial reaction products of an aromatic isocyanate material, an aliphatic isocyanate material or a combination of an aromatic isocyanate material and an aliphatic isocyanate material can also be used. Advantageously the isocyanate material comprises MDI material.

The MDI material can be isomeric MDI, polymeric MDI; modified MDI and combinations thereof. Methylene diphenyl diisocyanate (MDI) exists in the isomeric forms; 2,2′-MDI; 2,4′-MDI; and 4,4′-MDI. These isomers are solid at room temperature. Polymeric MDI is a complex mixture containing mixed monomeric MDI isomers and higher molecular weight oligoisocyanates. Oligoisocyanates are MDI homologues having 3 or more rings in the structure. Polymeric MDI is a liquid at room temperature.

[chemical structure]

MDI can be structurally modified in numerous ways to provide products more advantageous for selected applications. For example monomeric MDI can be modified by condensation reaction of the isocyanate groups to form carbodiimide and uretoimine modified MDI materials. These carbodiimide and uretoimine modified MDI materials are liquid at room temperature as compared to the solid monomeric MDI starting materials. MDI can also be modified by partially reacting the MDI monomers or polymeric MDI with polyols to form MDI polymers or prepolymers. The terms modified MDI polymer and modified MDI prepolymer are used interchangeably to mean a modified MDI material in which curing can be started by an accelerator component. These modified MDI prepolymers retain isocyanate functionality although the amount of free MDI monomer can be reduced. Modification of MDI allows variation of the physical properties, NCO content and functionality of the resultant molecule.

The modified MDI material includes residual NCO groups on the material backbone. The amount of residual NCO groups may be the result of the particular reactants used in formation of the modified MDI prepolymer. Generally, the residual NCO groups result from an excess stoichiometric amount of MDI or other isocyanate compound such that unreacted NCO remains on the formed backbone. Alternatively, the NCO groups may be added as pendent or end groups to a particular backbone.

In one advantageous variation the MDI material is a modified MDI prepolymer. In some embodiments the modified MDI material has a residual NCO content of about 8% to about 31% by weight of the MDI material.

The modified MDI material can have a variety of polymeric repeating groups or backbones. For example, the polymeric backbone may be formed from methylene diisocyanate and a polyester, a polyether or a polyester/polyether. Alternatively, the backbone may be formed from methylene diisocyanate and a polyurethane, polyurea or a polyurethane/polyurea. Various copolymers of polyurethane, polyester and polyethers may also be employed.

The modified MDI prepolymer can also be formed from the reaction product of MDI and at least one compound selected from a multifunctional alcohol, a polyamine, a polythiol, and combinations thereof. Other reactants useful for forming the modified MDI prepolymer include those obtained by reacting polyamines containing terminal, primary and secondary amine groups or polyhydric alcohols, for example, the alkane, cycloalkane, alkene and cycloalkene polyols such as glycerol, ethylene glycol, bisphenol-A, 4,4′-dihydroxy-phenyldimethylmethane-substituted bisphenol-A, and the like, with an excess of MDI. Useful alcohols for forming the modified MDI prepolymer include, without limitation, polyethylene glycol ethers having 3-7 ethylene oxide repeating units and one end terminated with an ether or an ester; polyether alcohols; polyester alcohols; as well as alcohols based on polybutadiene. One useful alcohol is 1,4-butanediol. Additional useful alcohols include, without limitation, castor oil, glycerin, polyethylene glycol, etherdiol, ethylene glycol, caprolactone polyols and combinations thereof.

Desirably, the modified MDI prepolymer is a polyester/polyurethane prepolymer, or a polyether/polyurethane prepolymer formed from the reaction of MDI material and an alcohol, with a sufficient amount of excess NCO groups present such that about 8% to about 31%, and more desirably about 18% to 28% of the total NCO groups initially present remain unreacted in the resultant prepolymer and available for moisture cure.

Modified MDI materials are available commercially. Useful modified MDI materials include those sold under the trade names LUPRANATE from BASF; MONDUR from Bayer Chemical, ISONATE from Dow Chemical and RUBINATE and SUPRASEC from Huntsman Chemical.

The modified MDI material desirably has a functionality of from about 2 to about 2.7, and most desirably about 2.1. Further, the modified MDI material backbone desirably has an equivalent weight ranging from about 525 to about 136, desirably about 233 to about 150.

The modified MDI material comprises from about 20 to about 95% by weight of the total curable composition.

The curable compositions described herein can include one or more cure accelerator components. A cure accelerator component will speed the rate at which the curable composition cures. Typically, catalysts suitable for accelerating a polyurethane gelling reaction may be useful in the curable composition.

One useful type of cure accelerator component is a metal compound. Useful metal compounds include metal salts typically selected from titanium, tin, zirconium, and combinations thereof. Suitable metal compounds include organo-metal catalysts including titanates, such as tetraisopropylorthotitanate and tetrabutoxyorthotitanate, as well as metal carboxylates such as dibutyltin laurate and dibutyltin dioctoate. Nonlimiting examples of metal compounds include, for example, dibutyltin dilaurate, dibutyltin diacetate, dibutyltin maleate, dialkyl tin hexoate, dioctyltin dilaurate, iron octanoate, zinc octanoate, lead octanoate, cobalt naphthenate, tetrapropyltitanate and tetrabutyltitanate. Other useful metal compounds known in the art to accelerate rate of cure may also be employed.

The metal cure accelerator component, if present, may be incorporated in any amount sufficient to effectuate cure and desirably from about 0.1 to about 1% by weight of the curable composition.

Some amine compounds can be useful as a cure accelerator component. These compounds include, for example, trimethylamine, triethylamine, tributylamine, trioctylamine, diethyl cyclohexylamine, N-methyl-morpholine, N-ethylmorpholine, N-octadecylmorpholine (N-cocomorpholine), N-methyl-diethanolamine, N,N-dimethylethanolamine, N,N′-bis(2-hydroxypropyl)piperazine, N,N,N′,N′-tetramethylethylene-diamine, N,N,N′,N′-tetramethyl-1,3-propanediamine, triethylenediamine, (1,4-diazabicyclo[2.2.2]octane), 1,8-diazabicyclo(5.4.0)undecene-7, 1,4-bis(2-hydroxypropyl)-2-methylpiperazine, N,N-dimethylbenzylamine, N,N-dimethyl-cyclohexylamine, benzyltriethylammonium bromide, bis(N,N-diethylaminoethyl)adipate, N,N-diethylbenzylamine, N-ethylhexamethyleneamine, N-ethylpiperidine, alpha-methyl-benzyldimethylamine, dimethylhexadecylamine, dimethylcetylamine, and the like. 1,4-diazabicyclo[2,2,2]octane is available from Air Products and Chemicals, Inc. of Pennsylvania as DABCO CRYSTALLINE. 1,8-diazabicyclo(5.4.0)undecene-7 is available from Air Products and Chemicals, Inc. of Pennsylvania as POLYCAT DBU.

The amine accelerator component can be reacted with, for example, an organic acid to form a blocked amine catalyst. Blocked amine catalysts display substantially lower room temperature catalyst ability compared to the non-blocked amine. However as the temperature of the curable composition rises non-blocked amine is released and the composition cure rate accelerates. Blocked amine catalysts are commercially available, for example POLYCAT SA-1 and DABCO 8154 both available from Air Products and Chemicals, Inc. of Pennsylvania. Other latent amines include the commercially available product Hardener OZ (a latent aliphatic polyaminoalcohol based on polyurethane bisoxazolidine, sold by Bayer Material Science, Pittsburgh, Pa.).

The amine accelerator component, if present, may be incorporated in any amount sufficient to effectuate cure and desirably from about 0.1 to about 10% by weight of the curable composition, and desirably about 0.1 to about 1.0% by weight of the composition. It is preferred that the amine cure accelerator or the blocked amine catalyst is kept separate from the modified MDI material until use to prevent premature curing.

The curable compositions described herein can include one or more cure initiator components. A cure initiator component will start and speed the rate at which the curable composition cures. One useful type of cure initiator component is a peroxy compound. Suitable peroxy compounds include e.g., peroxides, hydroperoxides, and peresters, which under appropriate elevated temperature conditions decompose to form peroxy free radicals which are effective for initiator and accelerating cure of the composition. The peroxy initiator component, if present, may be incorporated in any amount sufficient to effectuate cure and desirably from about 0.1 to about 3% by weight of the curable composition. It is preferred that the peroxy compound is kept separate from the modified MDI material until use to prevent premature curing.

One useful type of cure initiator component comprises azonitrile compounds which yield free radicals when decomposed by heat. Heat is applied to the curable composition and the resulting free radicals start and accelerate polymerization of the curable composition.

For example, azonitrile may be a compound of the formula:

[chemical structure]

where each R¹⁴ is independently selected from a methyl, ethyl, n-propyl, iso-propyl, iso-butyl or n-pentyl radical, and each R¹⁵ is independently selected from a methyl, ethyl, n-propyl, iso-propyl, cyclopropyl, carboxy-n-propyl, iso-butyl, cyclobutyl, n-pentyl, neo-pentyl, cyclopentyl, cyclohexyl, phenyl, benzyl, p-chlorobenzyl, or p-nitrobenzyl radical or R¹⁴ and R¹⁵, taken together with the carbon atom to which they are attached, represent a radical of the formula

[chemical structure]

where m is an integer from 3 to 9, or the radical, or

[chemical structure]

Compounds of the above formula are more fully described in U.S. Pat. No. 4,416,921, the disclosure of which is incorporated herein by reference.

Azonitrile initiators of the above-described formula are commercially available, e.q., the initiators which are commercially available under the trademark VAZO from E.I. DuPont de Nemours and Company, Inc., Wilmington, Del., including VAZO 52 (R¹⁴ is methyl, R¹⁵ is isobutyl), VAZO 64 (R¹⁴ is methyl, R¹⁵ is methyl), and VAZO 67 (R¹⁴ is methyl, R¹⁵ is ethyl), all such R¹⁴ and R¹⁵ constituents being identified with reference to the above-described azonitrile general formula. A desirable azonitrile initiator is 2,2′-azobis(iso-butyronitrile) or AZBN.

The azonitrile initiator component, if present, may be incorporated in any amount sufficient to effectuate cure and desirably from about 500 to about 10,000 parts per million (ppm) by weight of the curable composition, desirably about 1,000 to about 5,000 ppm.

In some embodiments the curable composition includes an anaerobic cure accelerator to accelerate curing in the absence of air. Examples of anaerobic cure accelerator components include amines (including amine oxides, sulfonamides and triazines). Other anaerobic cure accelerator components include saccharin, toluidenes, such as N,N-diethyl-p-toluidene and N,N-dimethyl-o-toluidene, acetyl phenylhydrazine, and maleic acid. Of course, other materials known to accelerator anaerobic cure may also be included or substituted therefore. See e.g. U.S. Pat. No. 3,218,305 (Krieble), U.S. Pat. No. 4,180,640 (Melody), U.S. Pat. No. 4,287,330 (Rich) and U.S. Pat. No. 4,321,349 (Rich), the disclosures of which are incorporated herein by reference.

The anaerobic cure accelerator component, if present, may be incorporated in any amount sufficient to effectuate cure and desirably in an amount of about 0.5% up to about 10% by weight of the total curable composition, such as in the range of about 3% to about 8% by weight of the total curable composition.

The curable composition can comprise a curable co-reactant component. One useful class of curable co-reactant components include at least one compound selected from a multifunctional alcohol, a polyamine, a polythiol, and combinations, thereof. Other useful curable co-reactant components include those obtained by reacting polyamines containing terminal, primary and secondary amine groups or polyhydric alcohols, for example, the alkane, cycloalkane, alkene and cycloalkene polyols such as glycerol, ethylene glycol, bisphenol-A, 4,4′-dihydroxy-phenyldimethylmethane-substituted bisphenol-A, and the like. Useful alcohols include, without limitation, polyethylene glycol ethers having 3-7 ethylene oxide repeating units and terminal hydroxy groups; polyether alcohols; polyester alcohols; as well as alcohols based on polybutadiene. One useful alcohol is 1,4-butanediol. Additional useful alcohols include, without limitation, castor oil, glycerin, polyethylene glycol, etherdiol, ethylene glycol, caprolactone polyols and combinations thereof.

Another useful class of curable co-reactant components are acrylates, for example the poly- and mono-functional (meth)acrylate esters. (Meth)acrylate esters include both acrylic esters and methacrylic esters. Some useful (meth)acrylic esters have the general structure CH₂═C(R)COOR¹, where R is H, CH₃, C₂H₅ or halogen, such as Cl, and R¹ is C₁₋₈ mono- or bicycloalkyl, a 3 to 8-membered heterocyclic radical with a maximum of two oxygen atoms in the heterocycle, H, alkyl, hydroxyalkyl or aminoalkyl where the alkyl portion is C₁₋₈ straight or branched carbon atom chain.

Some exemplary monofunctional polymerizable (meth)acrylate ester monomers include hydroxypropyl methacrylate, 2-hydroxyethyl methacrylate, methyl methacrylate, tetrahydrofurfuryl methacrylate, cyclohexyl methacrylate, 2-aminopropyl methacrylate and the corresponding acrylates. Some exemplary polyfunctional monomers include polyethylene glycol dimethacrylate and dipropylene glycol dimethacrylate.

Other useful acrylates include those which fall within the structure:

[chemical structure]

where R² may be selected from hydrogen, alkyl of 1 to about 4 carbon atoms, hydroxyalkyl of 1 to about 4 carbon atoms or

[chemical structure]

R³ may be selected from hydrogen, halogen, and alkyl of 1 to about 4 carbon atoms and C₁₋₈ mono- or bicycloalkyl, a 3 to 8 membered heterocyclic radical with a maximum of 2 oxygen atoms in the ring;
R⁴ may be selected from hydrogen, hydroxy and

[chemical structure]

m is an integer equal to at least 1, e.g., from 1 to about 8 or higher, for instance from 1 to about 4;
n is an integer equal to at least 1, e.g., 1 to about 20 or more; and
v is 0 or 1.

Other useful acrylates are those selected from urethane acrylates within the general structure:

(CH₂═CR⁵.CO.O.R⁶.O.CO.NH)₂R⁷

where R⁵ is H, CH₃, C₂H₅ or halogen, such as Cl; R⁶ is (i) a C₁₋₈ hydroxyalkylene or aminoalkylene group, (ii) a C₁₋₆ alklamino-C₁₋₈ alkylene, a hydroxyphenylene, aminophenylene, hydroxynaphthalene or amino-naphthalene optionally substituted by a C₁₋₃ alkyl, C₁₋₃ alkylamino or di-C₁₋₃ alkylamino group; and R⁷ is C₂₋₂₀ alkylene, alkenylene or cycloalkylene, C₆₋₄₀ arylene, alkarylene, aralkarylene, alkyloxyalkylene or aryloxyarylene optionally substituted by 1-4 halogen atoms or by 1-3 amino or mono- or di-C₁₋₃ alkylamino or C₁₋₃ alkoxy groups; or acrylates within the general structure:

(CH₂═CR⁵.CO.O.R⁶.O.CO.NH.R⁷.NH.CO.X—)ₙR⁸

where R⁵, R⁶, and R⁷ are as given above; R⁸ is a non-functional residue of a polyamine or a poihydric alcohol having at least n primary or secondary amino or hydroxy groups respectively; X is O or NR⁹, where R⁹ is H or a C₁₋₇ alkyl group; and n is an integer from 2 to 20.

Other useful acrylates can be selected from the class of the acrylate, methacrylate and glycidyl methacrylate esters of bisphenol A. Particularly useful are ethoxylated bisphenol-A-dimethacrylate (“EBIPMA”).

Other useful acrylates include those which are exemplified but not restricted to the following materials: di-, tri-, and tetra-ethylene glycol dimethacrylate, dipropylene glycol dimethacrylate, polyethylene g lycol dimethacrylate, di(pentamethylene glycol) dimethacrylate, tetraethylene glycol diacrylate, tetraethylene glycol di(chloroacrylate), diglycerol diacrylate, diglycerol tetramethacrylate, tetramethylene dimethacrylate, ethylene dimethacrylate, neopentyl glycol diacrylate and trimethylol propane triacrylate.

The acrylate co-reactant component need not be in the pure state, but may comprise commercial grades in which inhibitors or stabilizers, such as polyhydric phenols, quinones, and the like are included. These materials function as free radical inhibitors to prevent premature polymerization of the acrylate co-reactant component. It is also within the scope of the present disclosure to obtain modified characteristics for the cured composition by utilization of one or more monomers either from those listed above or additional additives such as unsaturated monomers, including unsaturated hydrocarbons and unsaturated esters.

Polymerizable vinyl monomers can also be optionally incorporated as co-reactant components and are represented by the general structure:

R¹⁰—CH═CH—R¹⁰

where each R¹⁰ is independently selected from alkyl, aryl, alkaryl, aralkyl, alkoxy, alkylene, aryloxy, aryloxyalky, alkoxyaryl, aralkylene, OOC—R¹, where R¹ is defined above, can also be effectively employed in the instant composition.

Another useful class of curable co-reactant components are amine terminated polymers, for example, one or more of:

Amine terminated polyethers such as linear amine-terminated polyoxyethylene ethers having the formula:

H₂N—(CH₂)₂—[O—(CH₂)₂—O—(CH₂)₂]ₙ—NH₂

in which n preferably is 17 to 27.

Amine terminated polyethers such as linear amine-terminated polyoxypropylene ethers having the formula:

[chemical structure]

in which n preferably is 5 to 100. They are obtainable from Huntsman Chemical under the trade name JEFFAMINE® (D-series). The number average molecular weight of such amine-terminated polyoxypropylene ethers may vary, for example, from about 200 to about 2000.

Amine terminated polyethers such as trifunctional compounds having the formula:

[chemical structure]

in which A is:

[chemical structure]

and x, y and z independently of each other are 1 to 40 and x÷y+z is preferably >6. Representative examples of these trifunctional compounds are available commercially from Huntsman Chemical under the tradename JEFFAMINE® (T-series). Such substances typically have number average molecular weights of from about 400 to about 5000.

Other exemplary commercially available amine terminated polymers include JEFFAMINE D-230, JEFFAMINE D-400, JEFFAMINE D-2000, JEFFAMINE T-403, JEFFAMINE ED-600, JEFFAMINE ED-900, JEFFAMINE ED-2001, JEFFAMINE EDR-148, JEFFAMINE XTJ-509, JEFFAMINE T-3000, JEFFAMINE T-5000, and combinations thereof, sold by Huntsman Corporation, Houston, Tex.

Mixtures or copolymers of any of curable co-reactants can be employed. The curable co-reactant, if present, may be incorporated in an amount of about 5% by weight to about 90% by weight of curable composition.

In one embodiment the curable composition includes a miscible or otherwise compatible polymeric matrix. The matrix material may be present in an amount sufficient to render the curable composition self supporting, i.e. non-flowable at temperatures of at least about 70° F. (21° C.), and up to about 160° F. (71° C.). The polymeric matrix and polymerizable component readily form a stable mixture or combination without phase separation of component parts. Suitable polymeric matrix materials are known. See U.S. Pat. Nos. 6,451,927; 6,727,320; 7,041,747 and 7,144,956, the contents of each of which are hereby incorporated by reference.

The curable composition can optionally include fillers. Such fillers may be selected from a wide variety of materials, including calcium carbonate, organic tin and zinc compounds and aluminum oxide, hydrated alumina and silica, etc. Other reinforcement properties can be achieved by adding carbon, glass, Kevlar and nano-organic or inorganic reinforcement materials. Such fillers may be present in any useful amount, and desirably in an amount of from about 5 to about 50% by weight and desirably about 10% to about 30% by weight of the composition.

The curable composition can optionally further include various additional composition modifiers such as diluents including reactive diluents, moisture scavengers, free radical scavengers, defoamers, viscosity modifiers, pigments, coloring agents, fluorescent material, plasticizers, stabilizers, and other such additives in amounts suitable to achieve their intended purpose. Typically, composition modifiers will comprise less than about 20% by weight of the curable composition.

The curable composition can be prepared as a singular composition or in two parts that are kept separate until use. In a two part composition one part comprises the MDI prepolymer and the other part comprises the curable co-reactant. Any accelerator will be included in the part that maximizes composition stability. Either part can include other components disclosed herein. Typically each part will be a substantially homogeneous mixture. Stirring and other forms of agitation are employed to facilitate the mixing process. The mixing is usually conducted at ambient pressure and ambient temperature, but temperatures up to about 35° C. can be useful. Generally, it is not necessary to shield the ingredients from oxygen during the preparation process, but sparging or blanketing the mixture with a non-reactive gas may be beneficially employed in instances wherein an ingredient exhibits undesirable air sensitivity. Useful non-reactive gases include nitrogen, helium, and argon.

A possible one part curable composition comprises:

| | |
|---|---|
| isocyanate material | 99-99.9% wt |
| cure accelerator | 0.1-1% wt |

A possible two part curable composition comprises:

### Part A

| | |
|---|---|
| isocyanate material | 99-99.9% wt |
| cure accelerator | 0.1-1% wt |

### Part B

| | | |
|---|---|---|
| curable acrylate co-reactant | 40-60% | by wt |
| multifunctional alcohol co-reactant | 35-45% | wt |
| cure accelerator | 1-8% | wt |
| cure initiator | 0-8% | wt |
| composition modifiers | 0-20% | by wt |

Parts A and B are kept separate until use to prevent premature curing. The two parts are mixed just before use. The parts can be mixed manually or with the use of mechanical devices such as a mix nozzle.

The mixed curable composition in the uncured state can have a range of viscosities, for example about 25 cp to about 40,000 centipoise (cP) at 25° C. (room temperature), depending on application. Lower viscosities are useful in applications where a more Plowable composition is desired while higher viscosities are useful in applications where less flow is desired. In addition, the composition in the cured state should be flexible and tough so as to absorb vibration that is present in a refrigeration system. The composition must also have good adhesive properties to maintain connection integrity under internal pressures more then 1200 pounds per square inch.

The curable composition will cure within about 24 hours at room temperature and about 50% relative humidity. Exposure of the composition to conditions appropriate to accelerate curing of the composition, for example temperatures of about 50° C. to about 150° C. for about 10 minutes and/or increased moisture will shorten the cure time of the composition.

Advantageously, the cured composition is dry-to-the-touch inside the bond area and outside the bond area. Dry-to-the-touch means tack-free. To determine whether a composition has a tack-free, dry-to-the-touch property a cured surface of the composition is dusted with talcum powder. The surface is considered tack-free or dry-to-the-touch if the talcum powder can be removed by light rubbing without causing the surface to become dull.

Advantageously, the disclosed compositions are curable in a commercially reasonable time on aerobic surfaces outside of the bond area, as well as anaerobic surfaces inside the bond area. This is a distinct advantage over materials which cure by traditional anaerobic only mechanisms, which are inhibited from curing outside the bond area, i.e., where exposed to the air. The term “curing”, or “cure” as used herein, refers to a change in state, condition, and/or structure in a material such as crosslinking of one or more materials in the curable composition.

Advantageously, the disclosed curable compositions are surface insensitive, and thus are capable of being adhered and cured to active and inactive surfaces. For example, the compositions may be adhered to “active surfaces” such as substrates or parts having iron or copper ions in them, for example steel; and “inactive surfaces” which do not have metal ions which aid in the cure of adhesive applied to their surfaces, such as zinc, stainless steel, plastic or polymer.

The compositions described herein may be better understood through the non-limiting Examples described below.

### EXAMPLES

A two part curable composition was prepared. The parts were kept separate until used.

### Part A

| | |
|---|---|
| low functionality, uretonimine modified MDI prepolymer¹ | 100% wt |

¹SUPRASEC 2029 available from Huntsman Corporation. This material is described by the manufacturer as a low functionality, uretonimine modified MDI material having a residual NCO content of about 24% by weight with an average NCO functionality of 2.1.

### Part B

| | |
|---|---|
| polyethyleneglycolmethacrylate | 24% wt |
| hydroxy terminated polypropyleneglycol methacrylate | 26% wt |
| defoamer¹ | 1% wt |
| Trimethylolpropane | 4% wt |
| 1,1-Dioxo-1,2-benzothiazol-3-one | 1% wt |
| 2-(bis(2-hydroxyethyl)amino)ethanol | 2% wt |
| catalyst² | .01% wt |
| tert-Butyl peroxybenzoate (TBPB) | 1% wt |
| polyether polyol³ | 39% wt |
| quinone stabilizer | 1% wt |
| Na EDTA based chelator | 1% wt |

¹BYK 054 available from BYK Chemie.
²DABCO T-12 available from Air Products and Chemicals, Inc.
³Poly G 450 from Arch Chemicals.

The mixture (1 part A to 1 part B by weight) was found to have a gel time (2.5 gram mass) of about 32 minutes.

A plurality of copper and aluminum tubes were provided. Each tube was a nominal 5/16 inch diameter. Each tube had a male or female distal portion in one end. The distal portions allowed approximately ½ inch to ¾ inch of lengthwise overlap and 0.002 to 0.006 inches of radial clearance between adjacent distal portions when the male distal portion was inserted in the female distal portion.

A pair of tubes one having a male distal portion and the other having a female distal portion was selected. The pair could both be copper or both be aluminum. The composition was provided as two separated parts in a dual chamber cartridge. The two parts were forced through a mix nozzle and the mixed composition was applied to one of the distal joint portions. The male distal joint portion was inserted into the female distal joint portion with no rotation between portions to obtain the overlap and held in place for about 30 seconds. After 30 seconds the composition had cured sufficiently to hold the tubes in position without assistance. The bonded assembly was allowed to cure at room temperature (RT) for a specified time before being subjected to a leak test. A new bonded assembly was used for each leak test.

### High (UL 250) Pressure Test:

The bonded assembly was allowed to room temperature cure for about 2 hours, followed by heating to 100° C. for 5 minutes and cooling to room temperature. The interior of the cured assembly was placed under pressure using oil. The internal pressure was increased to over 3,000 psi. Typically a minimum of three assemblies were tested.

### Thermal Cycle Test:

The bonded assembly was allowed to room temperature cure for 24 hours. The cured assembly was exposed to the following temperature cycle: hold at −18° C. for 1 hour, heat from −18° C. to 149° C. over 1 hour, hold at 149° C. for 1 hour, cool from 149° C. to −18° C. over 1 hour for 250 cycles. After completion of 250 cycles the bonded assembly was allowed to come to room temperature. The room temperature bonded assembly was secured in a tensile tester and placed under tension and the force required to break the bond was noted. Typically a minimum of three assemblies were tested.

Test results are summarized in the Table below.

Test Results Table

| | Cu to Cu | Al to Al |
|---|---|---|
| | assembly | assembly |
| adhesion after curing 1 hour at room temperature | 28 lb | — |
| adhesion after curing 2 hours at room temperature | 42 lb | — |
| adhesion after curing 24 hours at room | 582 lb | 518 lb |
| temperature | | |
| adhesion after curing 5 minutes at 82° C. and | 507 lb | |
| cooling 24 hours at room temperature | | |
| adhesion after curing 5 minutes at 150° C. and | 425 lb | |
| cooling 20 minutes at room temperature | | |
| adhesion after curing 15 minutes at 93° C. and | 274 lb | |
| cooling 20 minutes at room temperature | | |
| adhesion after curing 5 minutes at 100° C. and | 549 lb | |
| cooling 20 minutes at room temperature | | |
| adhesion after thermal cycle test | 544 lb | 538 lb |
| high pressure test (>3,000 psi) | no leaks | — |

1. A method of forming a high pressure connection, comprising:
providing a moisture curable composition comprising:
a curable isocyanate material, and
a cure accelerator component;
providing a first tubular member having a first distal joint portion and a second tubular member having a second distal joint portion;
applying the composition to one or both distal joint portions;
mating the first distal joint portion and the second distal joint portion to form a bond area;
exposing the composition to moisture sufficient to initiate curing of the curable composition inside and outside of the bond area to form the high pressure connection.

2. The method of claim 1, wherein the curable composition further comprises a curable (meth)acrylate co-reactant and an anaerobic accelerator component.

3. The method of claim 1, wherein the accelerator component is a heat cure catalyst.

4. The method of claim 1, wherein the isocyanate material is a curable MDI material having an NCO content of about 18% to about 28% by weight.

5. The method of claim 1, wherein the isocyanate material is a curable polyester modified MDI polymer.

6. The method of claim 1, wherein the isocyanate material is a curable polyether modified MDI polymer.

7. The method of claim 1, wherein the isocyanate material is a modified MDI polymer present in amounts of about 30% to about 95% by weight of the curable composition.

8. The method of claim 1, wherein the high pressure connection is dry-to-the-touch outside of the bond area.

9. The method of claim 1, wherein one of the distal joint portions is aluminum and the other of the distal joint portions is selected from copper, aluminum, steel, coated steel and plastic.

10. The method of claim 1, wherein the high pressure connection is part of a refrigeration system selected from a refrigerator, a freezer, a refrigerator-freezer, an air conditioner, an HVAC system or a heat pump.

11. The method of claim 1, further comprising the step of avoiding plastic deformation of the distal joint portions after the step of mating.

12. The method of claim 1 wherein the curable composition comprises a first part including the isocyanate material which is a modified MDI polymer and a second part including an alcoholic co-reactant, a (meth)acrylic co-reactant and an anaerobic accelerator component.

13. A high pressure connection made by the method of claim 1.

14. The high pressure connection of claim 13 consisting essentially of the distal joint portions and the cured composition.

15. The high pressure connection of claim 13 comprising a U shaped return bend.

16. The high pressure connection of claim 13, wherein the distal joint portions are threadedly interengaged in the bond area.

17. A heat exchanger comprising the high pressure connection of claim 13.

18. The heat exchanger of claim 17, comprising an elongated tube having a wall with an exterior surface defining the first distal joint portion and a pressurizable internal passageway and a component abutting at least a portion of the tube exterior surface;
the tube exterior surface bonded to the component by cured reaction products of the curable composition.

19. The heat exchanger of claim 18 wherein the component is a heat exchange fin angularly arranged with respect to the tube or a frame.

20. The article of manufacture of claim 18 wherein the component is the second distal joint portion.
